(19) United States
(12) Patent Application Publication
(10) Pub. No.: US 2017/0004782 A1
(43) Pub. Date: Jan. 5, 2017

(54) LIQUID CRYSTAL DISPLAY DEVICE

(71) Applicant: SHENZHEN CHINA STAR OPTOELECTRONICS TECHNOLOGY CO., LTD., Shenzhen, Guangdong (CN)

(72) Inventors: Yong FAN, Shenzhen, Guangdong (CN); Jianyu CHANG, Shenzhen, Guangdong (CN)

(21) Appl. No.: 14/777,233

(22) PCT Filed: Mar. 26, 2015
(86) PCT No.: PCT/CN2015/075121

§ 371 Date: Oct. 1, 2015

(30) Foreign Application Priority Data
Mar. 27, 2014 (CN) 201410118195.X

(51) Int. Cl. G09G 3/34; G02F 1/1335; G09G 3/36; G02F 1/1337; G09G 3/20; F21V 8/00; G02F 1/1368

(52) U.S. Cl. CPC G09G 3/3413; G02B 6/0073; G02F 1/133514; G02F 1/133621; G02B 6/0056; G02F 1/1368; G02F 1/1337; G02B 6/0068; G02F 1/133603; G09G 3/2003; G09G 3/342; G09G 3/3648; G02F 2001/133622; G09G 2310/0235; G09G 2320/0252; G09G 2320/0626

(57) ABSTRACT

A liquid crystal display device includes a backlight module, a liquid crystal panel, a color filter and a controller. The backlight module includes a light guide plate having a light-input surface and a light-output surface, a plurality of white LEDs and a plurality of blue LEDs. Both the white LED and the blue LED face to the light-input surface. The while LED includes a blue light chip for giving out blue light and phosphor powder excited by the blue light, and the blue LED includes a blue light chip. The liquid crystal panel is opposite to the light-output surface. The color filter is opposite to the liquid crystal panel. The color filter includes a red photoresist for red light to pass through only, a green photoresist for green light to pass through only and a transparent photoresist for light of any color to pass through.

### FIELD OF THE INVENTION

The present invention relates to the field of liquid crystal display, and more particularly, to a color liquid crystal display device with bi-color sequential backlight.

### BACKGROUND OF THE INVENTION

In a conventional liquid crystal display device, a color filter (Color Filter, CF) causes big losses to light, and approximately wastes two thirds of the light.In order to better utilize the backlight sources and reduce light losses, a liquid crystal display device employing a field sequential color (Field Sequential Color, FSC) technology without a color filter emerges at the right moment. The FSC technology particularly includes: displaying three subimages (red, green and blue) using a time sequence, and presenting a full color image on retinas via a time mixing color method through persistence of vision of human eyes. However, since there is a relative velocity between the human eyes and the image, the three subimages (red, green and blue) cannot be completely overlapped on the retinas, and color malposition phenomenon will appear at the edges, which produces color breakup (Color Breakup, CBU) phenomenon through persistence of vision, while this CBU phenomenon will severely affect the image quality displayed by the liquid crystal display device. Moreover, the FSC technology requires a higher screen brushing frequency, for example, the original screen brushing frequency of a full color image frequency is 60 HZ, while at least a screen brushing frequency of 180 HZ is required in case of using the FSC technology. However, the speed of response of liquid crystal molecules at present still cannot satisfy the requirement.

Therefore, it is necessary to provide a liquid crystal display device capable of solving the foregoing problems.

### SUMMARY OF THE INVENTION

To solve the foregoing technical problem, embodiments of the present invention provide a liquid crystal display device. The liquid crystal display device includes a backlight module, a liquid crystal panel, a color filter and a controller. The backlight module includes a light guide plate, a plurality of white LEDs for giving out white light and a plurality of blue LEDs for giving out blue light and corresponding to the plurality of white LEDs. The light guide plate includes a light-input surface and a light-output surface. Both the plurality of white LEDs and the plurality of blue LEDs face to the light-input surface. Each white LED includes a blue light chip for giving out blue light and phosphor powder excited by the blue light, and each blue LED includes a blue light chip. The liquid crystal panel is opposite to the light-output surface to receive light from the backlight module. The color filter is opposite to the liquid crystal panel and configured to receive light traversing through the liquid crystal panel. The color filter includes a red photoresist for red light to pass through only, a green photoresist for green light to pass through only and a transparent photoresist for light of any color to pass through. The controller is configured to control each white LED and corresponding blue LED to open according to a timing sequence and control a light valve in the liquid crystal panel to form images. The controller only enables the plurality of white LEDs to open in a first time, and only enables the blue LEDs corresponding to the plurality of white LEDs to open in a second time after the first time. A first frame image and a second frame image are formed after light given out by each white LED and corresponding blue LED passes through the light guide plate in sequence, the liquid crystal panel and the color filter; and the first frame image and the second frame image are overlaid to form a full color image.

Wherein, the liquid crystal display device further includes a first polaroid, and the first polaroid is located between the liquid crystal panel and the backlight module.

Wherein, the liquid crystal display device further includes a second polaroid, the second polaroid is opposite to the color filter, and the second polaroid and the liquid crystal panel are respectively located at the two opposite sides of the color filter.

Wherein, the liquid crystal panel includes a thin film transistor array substrate, a liquid crystal layer and an orientation layer, and the thin film transistor array substrate, the liquid crystal layer and the orientation layer are arranged in sequence on a direction from the backlight module to the color filter.

Wherein, the backlight module is a lateral-entering type structure.

Wherein, the backlight module further includes a circuit board, the light guide plate includes a light-input surface, the circuit board is opposite to the light-input surface, and the plurality of white LEDs and the plurality of blue LEDs alternate mutually and are disposed on the circuit board in a mutually spaced manner.

Wherein, the plurality of white LEDs and the plurality of white LEDs are arranged in a straight line.

Wherein, the backlight module further includes a first circuit board and a second circuit board, the light guide plate includes a first light-input surface and a second light-input surface that are opposite, the first circuit board and the second circuit board are respectively located at the two opposite sides of the light guide plate and are respectively opposite to the first light-input surface and the second light-input surface, the plurality of blue LEDs are disposed on the first circuit board in a mutually spaced manner, and the plurality of white LEDs are disposed on the second circuit board in a mutually spaced manner.

Wherein, the plurality of blue LEDs are arranged in a straight line and the plurality of white LEDs are arranged in a straight line.

Wherein, the backlight module is a direct back-lit structure.

Wherein, the backlight module further includes a circuit board, the light guide plate includes a light-input surface, the circuit board is opposite to the light-input surface, one white LED and one corresponding blue LED together form an LED light-emitting group, and a plurality of LED light-emitting groups are arranged on the circuit board in a matrix type and opposite to the light-input surface.

Wherein, each white LED further includes a glass cover, the glass cover covers the blue light chip, and the phosphor powder is coated on the inner surface of the glass cover.

Wherein, each blue LED further includes a glass cover, and the glass cover covers the blue light chip.

Wherein, the phosphor powder is selected from any one of yellow powder, RG phosphor powder and Y+R phosphor powder.

Wherein, the phosphor powder is made of any one of Y₃A1₅O₁₂:Ce³⁺, Tb₃Al₅O₁₂: Ce³⁺, nitride and silicate.

Wherein, the backlight module is a flat-plate structure.

Wherein, the light guide plate is a wedge-shaped structure.

The first frame image produced by the liquid crystal display device provided by the present invention has the frame information of red, green and white, and the second image produced thereof only has the frame information of blue, then the color breakup phenomenon is greatly reduced. Moreover, it only needs to fresh the screen when forming the first frame image and the second frame image if the liquid crystal display device wants to display a full color image, and a screen brushing frequency of 120HZ is needed only, which complies with the speed of response of the liquid crystal molecules.

### BRIEF DESCRIPTION OF THE DRAWINGS

In order to explain the technical solutions in the embodiments of the invention or in the related art more clearly, the drawings used in the descriptions of the embodiments or the related art will be simply introduced hereinafter. It is apparent that the drawings described hereinafter are merely some embodiments of the invention, and those skilled in the art may also obtain other drawings according to these drawings without going through creative work.

FIG. 1 is a plan schematic view of a liquid crystal display device provided by a first embodiment of the invention;

FIG. 2 is a plan schematic view of a backlight module of the liquid crystal display device in FIG. 1;

FIG. 3 is a schematic view of the liquid crystal display device in FIG. 1 for displaying a full color image;

FIG. 4 is a plan schematic view of a backlight module in a liquid crystal display device provided by a second embodiment of the invention;

FIG. 5 is a plan schematic view of a backlight module in a liquid crystal display device provided by a third embodiment of the invention; and

FIG. 6 is a plan schematic view of the black module in FIG. 5 after removing a light guide plate.

### DETAILED DESCRIPTION OF THE PREFERRED EMBODIMENTS

Further illustrative explanations will be made clearly and completely to the technical solutions in the embodiments of the invention hereinafter with reference to the accompanying drawings in the embodiments of the invention. Apparently, the embodiments described are merely partial embodiments of the present invention, rather than all embodiments. Other embodiments derive by those having ordinary skills in the art on the basis of the embodiments of the invention without going through creative efforts shall all fall within the protection scope of the present invention.

### Embodiment 1

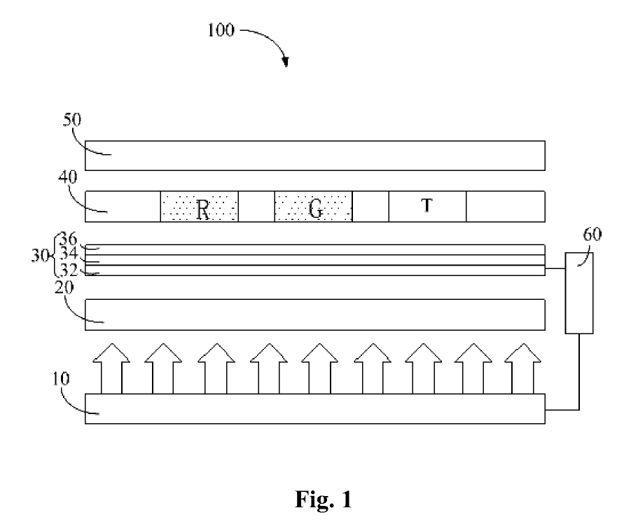

Please refer to FIG. 1. A liquid crystal display device 100 provided by the first embodiment of the present invention includes a backlight module 10, a first polaroid 20, a liquid crystal panel 30, a color filter 40, a second polaroid 50 and a controller 60.

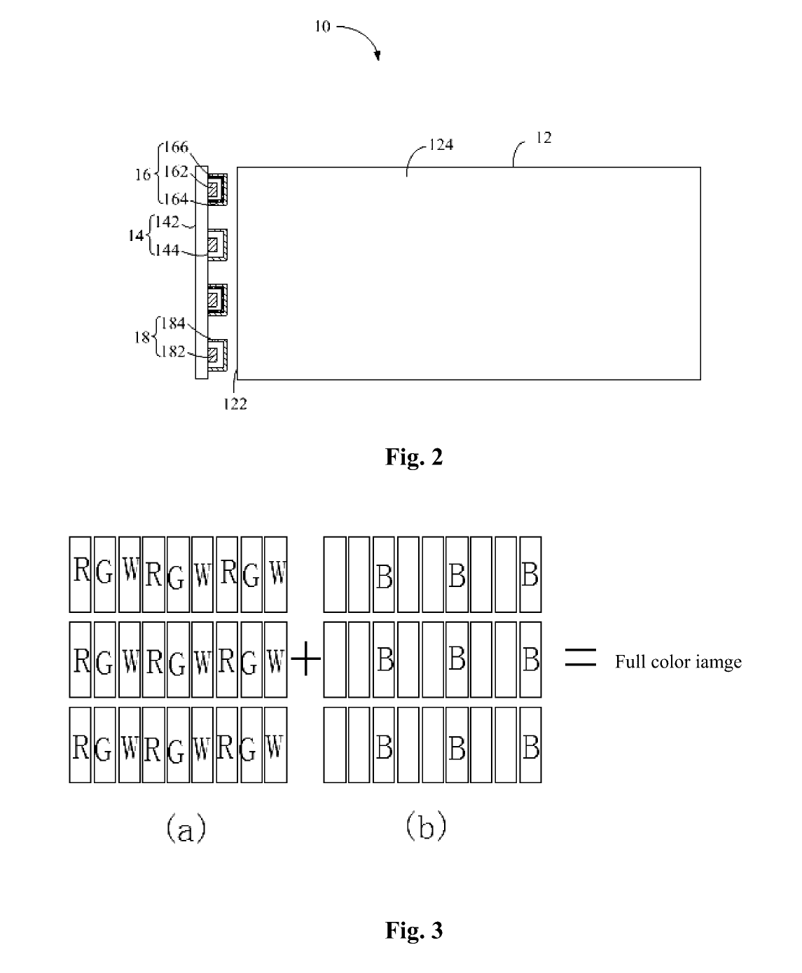

Please refer to FIG. 2. The backlight module 10 is a lateral-entering type structure, which includes a light guide plate 12, a circuit board 14, a plurality of white light emitting diodes (white light emitting diode, WLED) (hereinafter referred to as white LED) 16 and a plurality of blue light emitting diodes (blue light emitting diode, BLED) (hereinafter referred to as blue LED) 18. The plurality of white LEDs 16 and the plurality of blue LEDs 18 correspond one to one. To facilitate explanation, only two white LEDs and two blue LEDs are taken as an example for explanation in the embodiment.

The light guide plate 12 can be a flat-plate structure or a wedge-shaped structure, and includes a light-input surface 122 and a light-output surface 124. The light-output surface 124 is vertically connected to the light-input surface 122.

The circuit board 14 includes a first surface 142 and a second surface 144. The first surface 142 and the second surface 144 are respectively located at the two opposite sides of the circuit board 14, and the first surface 142 is parallel with the second surface 144. The second surface 144 and the light-input surface 122 are just opposite to each other in parallel.

The plurality of white LEDs 16 and the plurality of blue LEDs 18 alternate mutually and are disposed on the second surface 144 of the circuit board 14 in a mutually spaced manner in a straight line so as to be just opposite to the light-input surface 122. Each white LED 16 includes a blue light chip 162, a glass cover 164 covering the blue light chip 162 and phosphor powder 166 coated on the inner surface of the glass cover 164. The blue light chip 162 is configured to give out blue light. The phosphor powder 166 excited by the blue light is configured to form white light and emitted from the glass cover 164. The phosphor powder 166 is selected from any one of yellow powder, RG phosphor powder and Y+R phosphor powder. Particularly, the phosphor powder 166 is made of any one of Y₃Al₅O₁₂:Ce³⁺(YAG), Tb₃Al₅O₁₂: Ce³⁺(TAG), nitride and silicate. Each blue LED 18 includes a blue light chip 182 and a glass cover 184 covering the blue light chip 182. Blue light given out by the blue light chip 182 is emitted from the glass cover 184.

The first polaroid 20, the liquid crystal panel 30, the color filter 40 and the second polaroid 50 are arranged above the light-output surface 124 in sequence and are all just opposite to the light-output surface 124. The liquid crystal panel 30 includes a thin film transistor array substrate 32, a liquid crystal layer 34 and an orientation layer 36. The thin film transistor array substrate 32, the liquid crystal layer 34 and the orientation layer 36 are arranged in sequence on a direction from the backlight module 10 to the color filter 40. The color filter 40 is opposite to the liquid crystal panel 30. The color filter 40 includes a red photoresist for red light to pass through only R, a green photoresist for green light to pass through only G and a transparent photoresist for light of any color to pass through T.

The controller 60 is electrically connected with the liquid crystal panel 30 and the backlight module 10. The controller 60 is configured to control each white LED 16 and corresponding blue LED 18 in the backlight module 10 to open according to a timing sequence and control a light valve in the liquid crystal panel 30 to form images.

Please refer to FIG. 3. When the liquid crystal panel 100 works, the controller 60 only enables the plurality of white LEDs 16 to open in a first time. The blue light chip 162 in each white LED 16 gives out blue light. The blue light excites the phosphor powder 166 to form white light, and emit the white light from the glass cover 164. The white light emitted from the glass cover 164 enters the interior of the light guide plate 12 from the light-input surface 122 and is emitted from the light-output surface 124 after multiple reflection inside the light guide plate. The white light emitted from the light-output surface 124 after passing through the first polaroid 20, the liquid crystal panel 30, the color filter 40 and the second polaroid 50 forms a first frame image (a). Since the red photoresist R of the color filter 40 is only for red light to pass through, the green photoresist G is only for green light to pass through, and the transparent photoresist T can allow light of any color to pass through, then the first frame image (a) has the image information of red R, green G and white W, wherein the gray-scale values of the red R, green G and white W of each sub-pixel are determined by the information of the image to be displayed. The controller 60 only enables the plurality of blue LEDs 18 corresponding to the plurality of white LEDs 16 to open in a second time after the first time. The blue light chip 182 in each blue LED 18 gives out blue light and emit the blue light from the glass cover 184. The blue light emitted from the glass cover 184 enters the interior of the light guide plate 12 from the light-input surface 122 and is emitted from the light-output surface 124 after multiple reflection inside the light guide plate. The blue light emitted from the light-output surface 124 after passing through the first polaroid 20, the liquid crystal panel 30, the color filter 40 and the second polaroid 50 forms a second frame image (b). Since the red photoresist R of the color filter 40 is only for red light to pass through, the green photoresist G is only for green light to pass through, and the transparent photoresist T can allow light of any color to pass through, then the second frame image (b) only has the frame information of blue B, wherein the gray-scale value of the blue B of each sub-pixel is determined by the information of the image to be displayed. The first frame image (a) and the second frame image (b) are overlaid to form a full color image for a user to view. During this process, the dominant wavelengths of the blue light given out by the blue light chip 162 of the white LED 16 and the blue light given out by the blue light chip 182 of the blue LED 18 have the same wave bands, the peak wavelengths thereof range from 440 nm to 470 nm, and the difference of the dominant wavelengths of the types of blue light is within 5 nm.

The first frame image (a) of FIG. 3 produced by the liquid crystal display device 100 in the embodiment has the frame information of red R, green G and white W, and the second frame image (b) of FIG. 3 only has the frame information of blue B, then a color breakup phenomenon is greatly reduced. Moreover, it only needs to fresh the screen when forming the first frame image (a) of FIG. 3 and the second frame image (b) of FIG. 3 if the liquid crystal display device 100 wants to display a full color image, and a screen brushing frequency of 120 HZ is needed only, which complies with the speed of response of the liquid crystal molecules. Moreover, since both the white LED 16 and the blue LED 18 employ the blue chip to give out light, then the life attenuation curves of the white LED 16 and the blue LED 18 are consistent, which greatly reduces color drift of the backlight module 10 caused by long term use. Moreover, since the energy efficiency of the white LED 16 is greater than the energy efficiency of red light and green light single chips at present, the drive power consumption of the backlight module 10 can be reduced.

### Embodiment 2

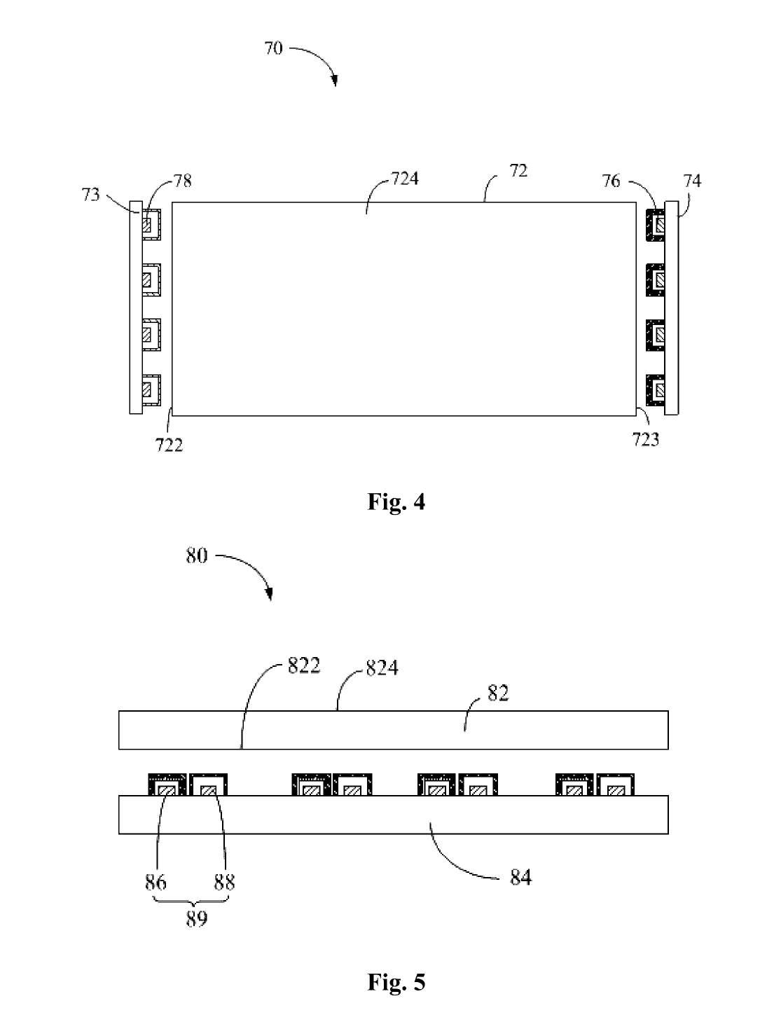

Please refer to FIG. 4. The structure of a liquid crystal display device provided by the second embodiment of the present invention is substantially identical to that of the liquid crystal display device 100 in the first embodiment, where the difference is that a backlight module 70 in the embodiment is different from the backlight module 10 in the first embodiment. The difference is particularly as follows: the backlight module 70 is a lateral-entering type structure, which includes a light guide plate 72, a first circuit board 73, a second circuit board 74, a plurality of white LEDs 76 for giving out white light and a plurality of blue LEDs 78 for giving out blue light. The plurality of white LEDs 76 and the plurality of blue LEDs 78 correspond one to one.

The light guide plate 72 can be a flat-plate structure or a wedge-shaped structure, and includes a first light-input surface 722, a second light-input surface 723 and a light-output surface 724. The first light-input surface 722 and the second light-input surface 723 are respectively located at the two opposite sides of the light guide plate 22, and the first light-input surface 722 is parallel with the second light-input surface 723. The light-output surface 724 is vertically connected to the light-input surface 722 and the second light-input surface 723.

The first circuit board 73 and the second circuit board 74 are respectively located at the two opposite sides of the light guide plate 72 and are respectively opposite to the first light-input surface 722 and the second light-input surface 723. The specific structures of the first circuit board 73 and the second circuit board 74 are completely identical to the specific structure of the circuit board 14 in the first embodiment. The plurality of blue LEDs 78 are disposed on the first circuit board 73 in a mutually spaced manner in a straight line so as to be just opposite to the first light-input surface 722. The plurality of white LEDs 76 are disposed on the second circuit board 74 in a mutually spaced manner in a straight line so as to be just opposite to the second light-input surface 723.

The advantageous effects of the liquid crystal display device in the embodiment are completely identical to the advantageous effects of the liquid crystal display device 100 in the first embodiment; moreover, the working principle of the liquid crystal display device in the embodiment is completely identical to the working principle of the liquid crystal display device 100 in the first embodiment, which will not be elaborated hereon.

### Embodiment 3

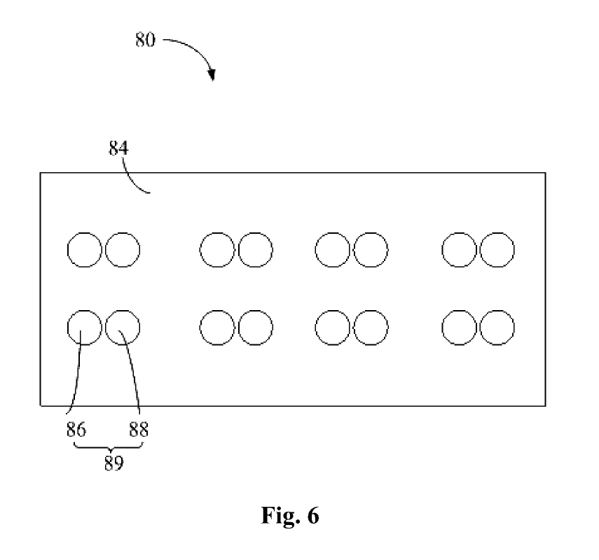

Please refer to FIG. 5 and FIG. 6. The structure of a liquid crystal display device provided by the third embodiment of the present invention is substantially identical to that of the liquid crystal display device 100 in the first embodiment, where the difference is that a backlight module 80 in the embodiment is different from the backlight module 10 in the first embodiment. The difference is particularly as follows: the backlight module 80 is a direct back-lit structure, which includes a light guide plate 82, a circuit board 84, a plurality of white LEDs 86 for giving out white light and a plurality of blue LEDs 88 for giving out blue light. The plurality of white LEDs 86 and the plurality of blue LEDs 88 correspond one to one.

The light guide plate 82 can be a flat-plate structure or a wedge-shaped structure, and includes a light-input surface 822 and a light-output surface 824. The light-input surface 822 and the light-output surface 824 are respectively located at the two opposite sides of the light guide plate 82.

The circuit board 84 is located below the light guide plate 82 and is opposite to the light-input surface 822. The specific structures of the circuit board 84 is completely identical to the specific structure of the circuit board 14 in the first embodiment. One white LED 86 and one corresponding blue LED 88 together form an LED light-emitting group 89. The plurality of LED light-emitting groups 89 are arranged on the circuit board 84 in a matrix type and are opposite to the light-input surface 822. Each white LED 86 and each corresponding blue LED 88 in the plurality of LED light-emitting groups 89 are started according to a timing sequence as that in the first embodiment, and the difference is that the light given out enters the light guide plate 82 from the light-input surface 822.

The advantageous effects of the liquid crystal display device in the embodiment are completely identical to the advantageous effects of the liquid crystal display device 100 in the first embodiment; moreover, the working principle of the liquid crystal display device in the embodiment is completely identical to the working principle of the liquid crystal display device 100 in the first embodiment, which will not be elaborated hereon.

The above disclosed is merely preferred embodiments of the present invention, which certainly cannot be intended to define the right scope of the present invention; therefore, equivalent variations figured out according to the claims of the present invention shall still fall within the scope encompassed by the present invention.

What is claimed is:

1. A liquid crystal display device, comprising:
a backlight module, the backlight module comprising a light guide plate, a plurality of white light emitting diodes (LEDs) for giving out white light and a plurality of blue LEDs for giving out blue light and corresponding to the plurality of white LEDs, the light guide plate comprising a light-input surface and a light-output surface, both the plurality of white LEDs and the plurality of blue LEDs face to the light-input surface, each white LED comprising a blue light chip for giving out blue light and phosphor powder excited by the blue light, and each blue LED comprising a blue light chip;
a liquid crystal panel, the liquid crystal panel being opposite to the light-output surface to receive light from the backlight module;
a color filter, the color filter being opposite to the liquid crystal panel and configured to receive light traversing through the liquid crystal panel, the color filter comprising a red photoresist for red light to pass through only, a green photoresist for green light to pass through only and a transparent photoresist for light of any color to pass through; and
a controller, the controller being configured to control each white LED and corresponding blue LED to open according to a timing sequence and control a light valve in the liquid crystal panel to form images; the controller only enabling the plurality of white LEDs to open in a first time, and only enabling the blue LEDs corresponding to the plurality of white LEDs to open in a second time after the first time; a first frame image and a second frame image being formed after light given out by each white LED and corresponding blue LED passes through the light guide plate in sequence, the liquid crystal panel and the color filter; and the first frame image and the second frame image being overlaid to form a full color image.

2. The liquid crystal display device according to claim 1, wherein the liquid crystal display device further comprises a first polaroid, and the first polaroid is located between the liquid crystal panel and the backlight module.

3. The liquid crystal display device according to claim 2, wherein the liquid crystal display device further comprises a second polaroid, the second polaroid is opposite to the color filter, and the second polaroid and the liquid crystal panel are respectively located at the two opposite sides of the color filter.

4. The liquid crystal display device according to claim 1, wherein the liquid crystal panel comprises a thin film transistor array substrate, a liquid crystal layer and an orientation layer, and the thin film transistor array substrate, the liquid crystal layer and the orientation layer are arranged in sequence on a direction from the backlight module to the color filter.

5. The liquid crystal display device according to claim 1, wherein the backlight module is a lateral-entering type structure.

6. The liquid crystal display device according to claim 5, wherein the backlight module further comprises a circuit board, the light guide plate comprises a light-input surface, the circuit board is opposite to the light-input surface, and the plurality of white LEDs and the plurality of blue LEDs alternate mutually and are disposed on the circuit board in a mutually spaced manner.

7. The liquid crystal display device according to claim 6, wherein the plurality of white LEDs and the plurality of blue LEDs are arranged in a straight line.

8. The liquid crystal display device according to claim 5, wherein the backlight module further comprises a first circuit board and a second circuit board, the light guide plate comprises a first light-input surface and a second light-input surface that are opposite, the first circuit board and the second circuit board are respectively located at the two opposite sides of the light guide plate and are respectively opposite to the first light-input surface and the second light-input surface, the plurality of blue LEDs are disposed on the first circuit board in a mutually spaced manner, and the plurality of white LEDs are disposed on the second circuit board in a mutually spaced manner.

9. The liquid crystal display device according to claim 8, wherein the plurality of blue LEDs are arranged in a straight line, and the plurality of white LEDs are arranged in a straight line.

10. The liquid crystal display device according to claim 1, wherein the backlight module is a direct back-lit structure.

11. The liquid crystal display device according to claim 10, wherein the backlight module further comprises a circuit board, the light guide plate comprises a light-input surface, the circuit board is opposite to the light-input surface, one white LED and one corresponding blue LED together form an LED light-emitting group, and a plurality of LED light-emitting groups are arranged on the circuit board in a matrix type and opposite to the light-input surface.

12. The liquid crystal display device according to claim 1, wherein each white LED further comprises a glass cover, the glass cover covers the blue light chip, and the phosphor powder is coated on the inner surface of the glass cover.

13. The liquid crystal display device according to claim 1, wherein each blue LED further comprises a glass cover, and the glass cover covers the blue light chip.

14. The liquid crystal display device according to claim 1, wherein the phosphor powder is selected from any one of yellow powder, RG phosphor powder and Y+R phosphor powder.

15. The liquid crystal display device according to claim 1, wherein the phosphor powder is made of any one of Y₃Al₅O₁₂:Ce³⁺, Tb₃Al₅O₁₂: Ce³⁺, nitride and silicate.

16. The liquid crystal display device according to claim 1, wherein the light guide plate is a flat-plate structure

17. The liquid crystal display device according to claim 1, wherein the light guide plate is a wedge-shaped structure.
